(19) United States
(12) Patent Application Publication
(10) Pub. No.: US 2008/0005766 A1
(43) Pub. Date: Jan. 3, 2008

(54) Enhanced Program Guide

(75) Inventors: Barbara E. Ostrowska, Lawrenceville, GA (US); Man S. Chiu, Alpharetta, GA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/427,488

(22) Filed: Jun. 29, 2006

(51) Int. Cl. H04N 5/445

(52) U.S. Cl. 725/53; 725/39; 725/44

(57) ABSTRACT

Included are systems and methods for providing an enhanced program guide. At least one embodiment of a method includes receiving a request to provide a plurality of program titles in a browsing format and determining whether at least one of the program titles is a duplicate program title. Other embodiments include, providing a display that includes the requested program titles, the display excluding the at least one duplicate program title, and the display providing an option to view the at least one duplicate program title. Still other embodiments include providing the at least one duplicate program title according to a time-dependent format.

### TECHNICAL FILED

The present disclosure is related to a programming guide. More specifically, the present disclosure is related to interactive program menus for navigating a plurality of programs.

### BACKGROUND

As communication bandwidth has increased, users of media networks have been provided with an increasing number of options for programming. More specifically, while users were once provided with four television channels, now hundreds of programming channels are available, as well as interactive applications. Because of the large number of options now available, users often utilize a Set Top Terminal (STT), which may include an Interactive Programming Guide (IPG). The IPG can be configured with a graphical user interface for navigating the plurality of programming channels and/or services provided in the media network. In addition, the IPG can include logic for arranging the programming options in one or more configurations, including arranging the programming options by title, channel, and/or theme. While the arrangement functions have proved beneficial for allowing users to locate a desired program, oftentimes, multiple instances of the same program are displayed. As such the user may have to scroll through a plurality of undesired programs to reach a desired program.

Thus, a heretofore unaddressed need exists in the industry to address the aforementioned deficiencies and inadequacies.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

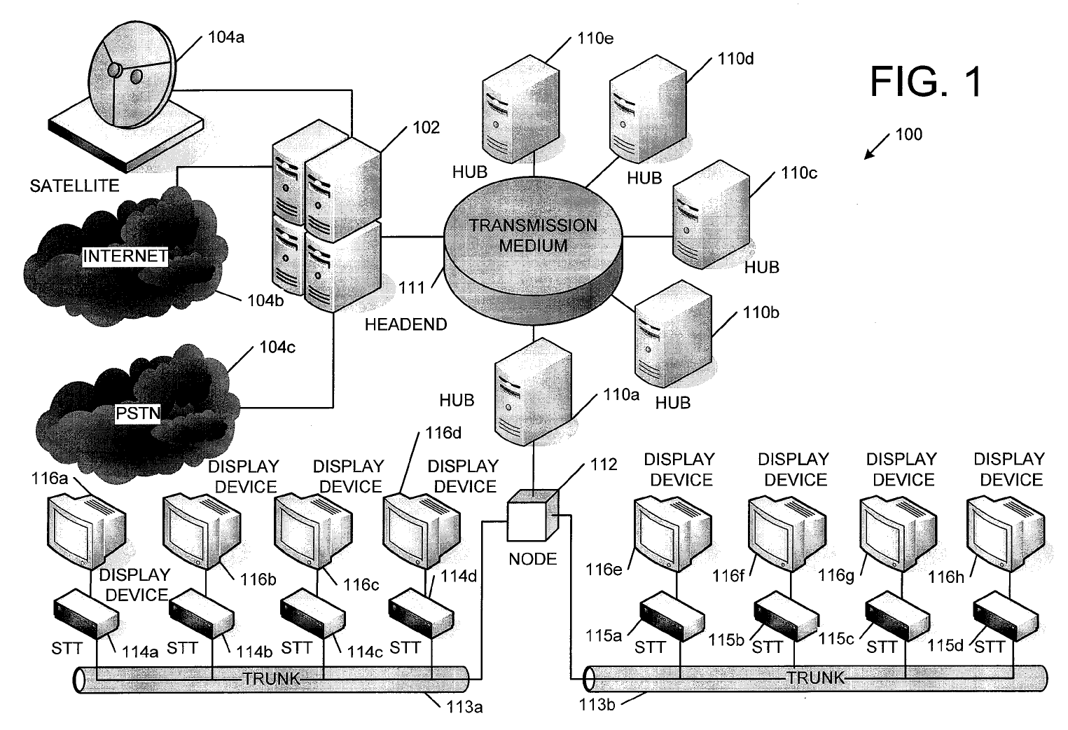

FIG. 1 is a network diagram illustrating a plurality of STTs in operation.

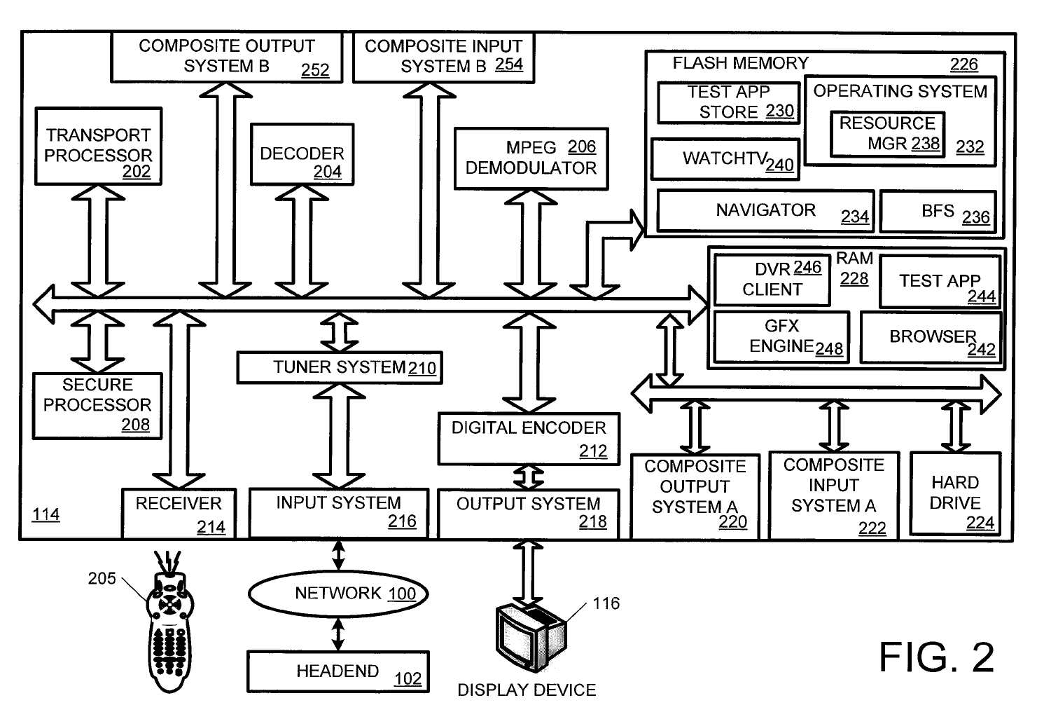

FIG. 2 is a block diagram illustrating exemplary components of an STT, similar to an STT from FIG. 1.

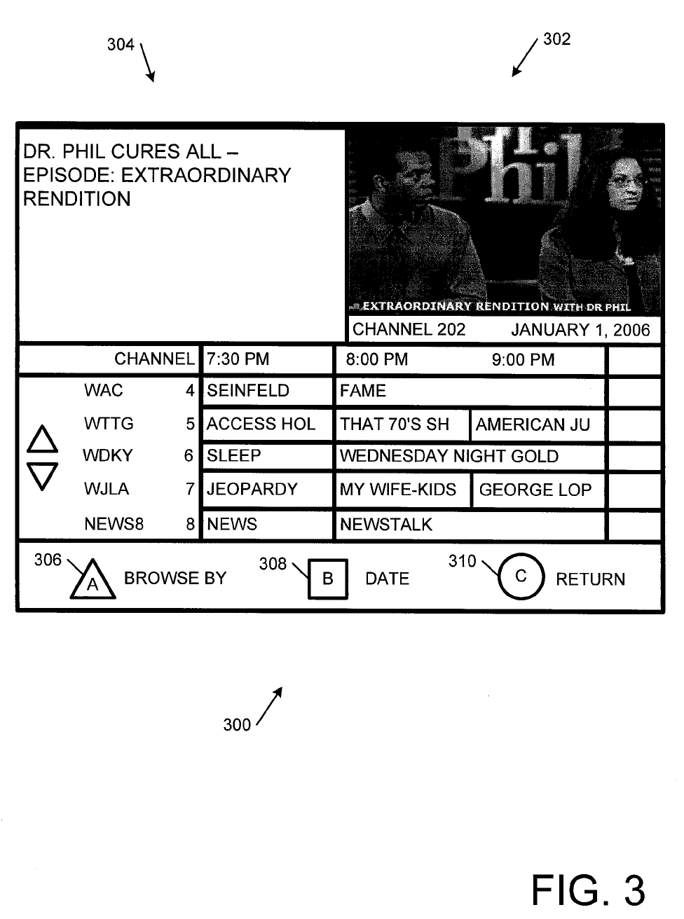

FIG. 3 is an embodiment of a program guide display for presenting a plurality of program titles to a user, such as a user of the STT from FIG. 2.

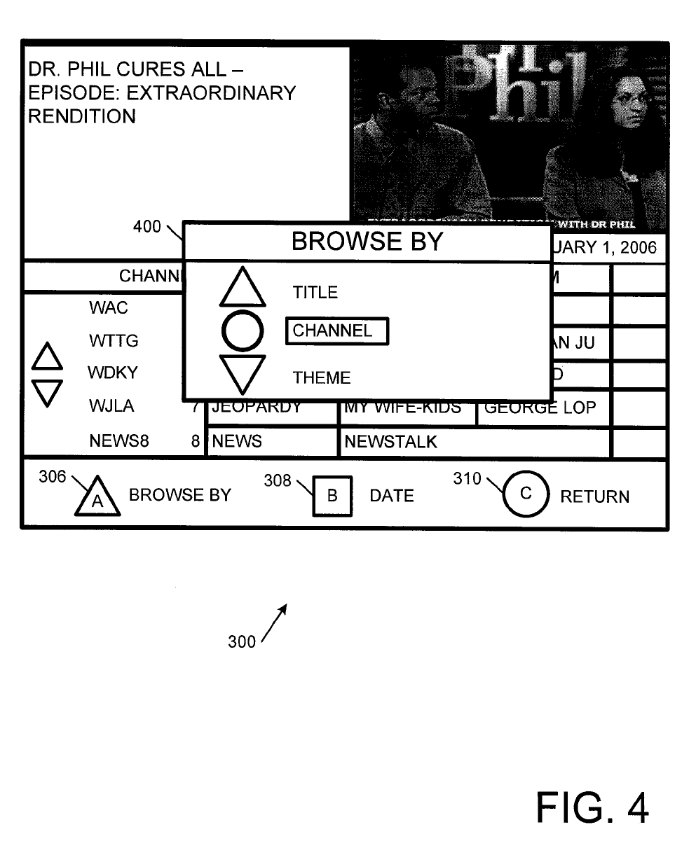

FIG. 4 is an embodiment of a programming display for selecting a display configuration of the program titles from FIG. 3.

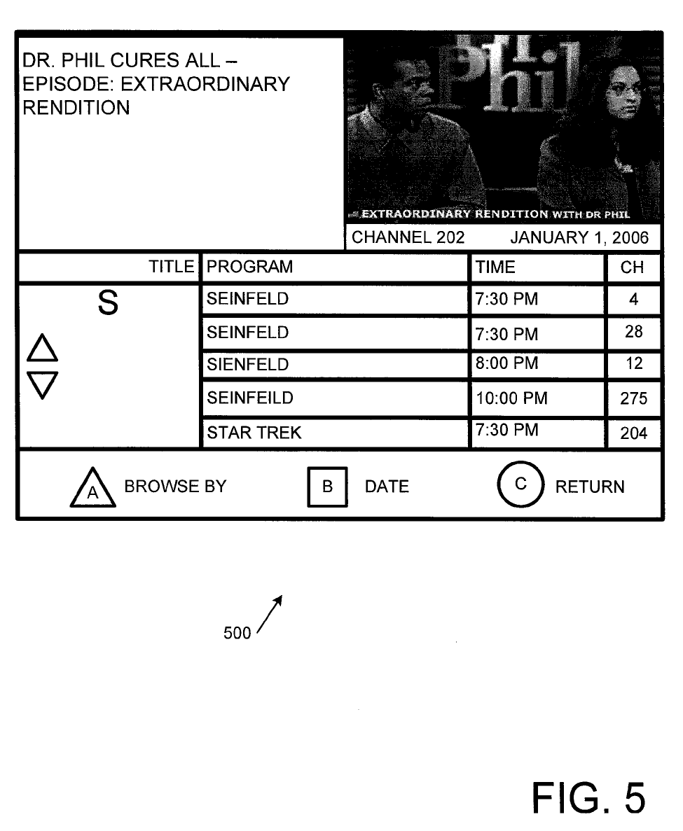

FIG. 5 is an embodiment of a programming display for presenting a plurality of programming titles in a browsing format according to title, similar to the display from FIG. 4.

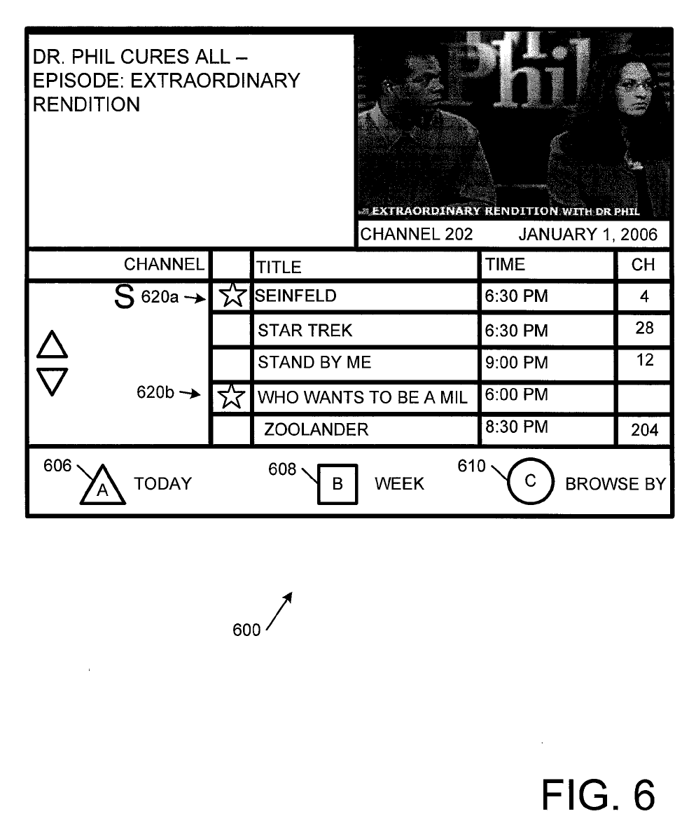

FIG. 6 is an embodiment of a programming display for presenting a plurality of programming titles in a browsing format with access to duplicate programming titles, similar to the display from FIG. 5.

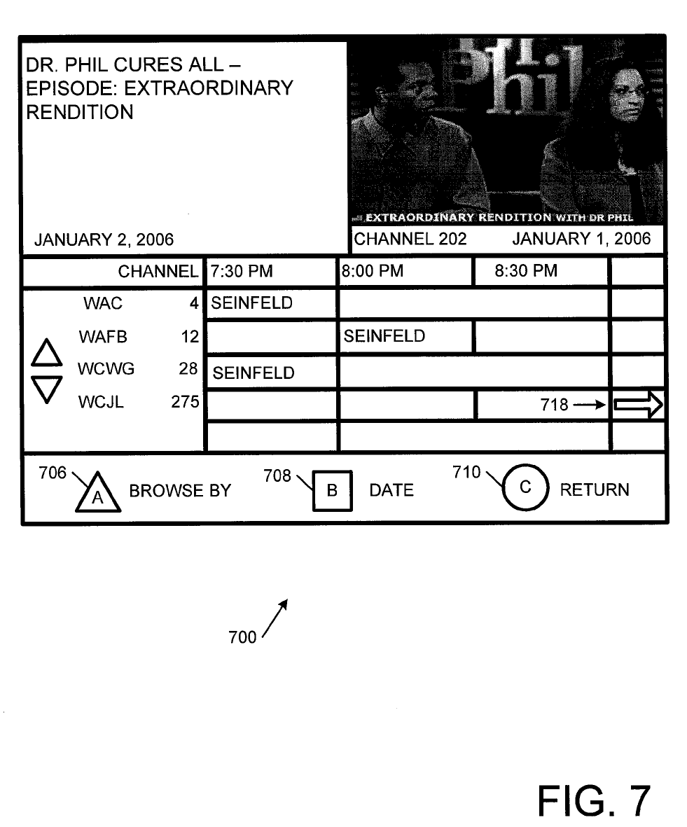

FIG. 7 is an embodiment of a programming display, illustrating a browsing format with a plurality of duplicate titles for a particular day, similar to the display from FIG. 7.

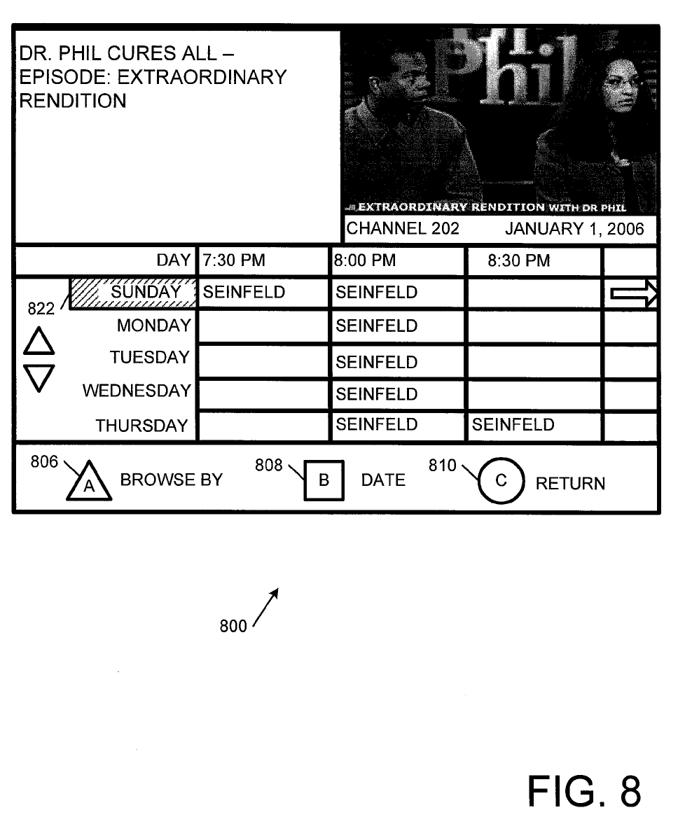

FIG. 8 is an embodiment of a programming display, illustrating a browsing format with plurality of duplicate titles for a particular week, similar to the display from FIG. 7.

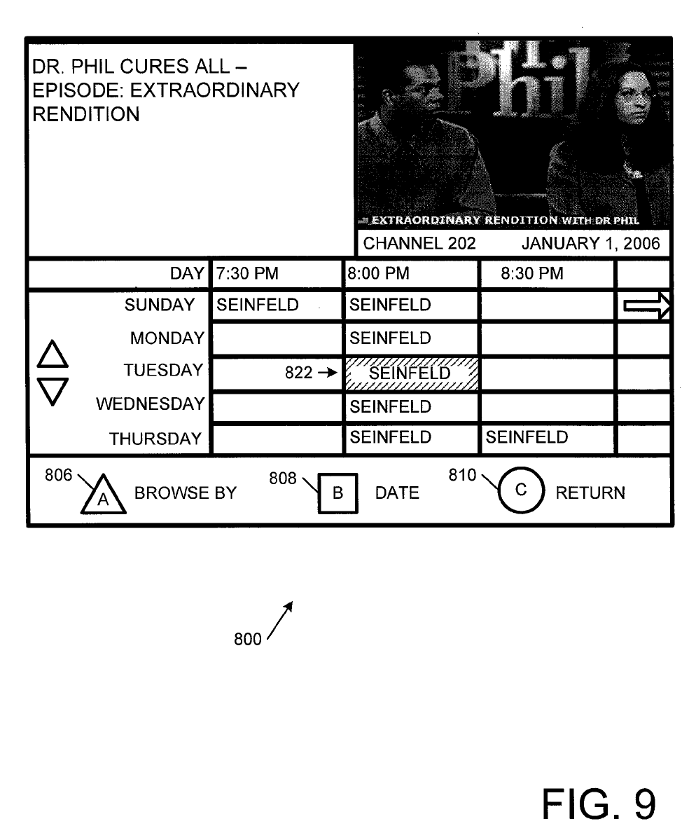

FIG. 9 is an embodiment of a programming display, illustrating selection of a program title, such as a program title from FIG. 8.

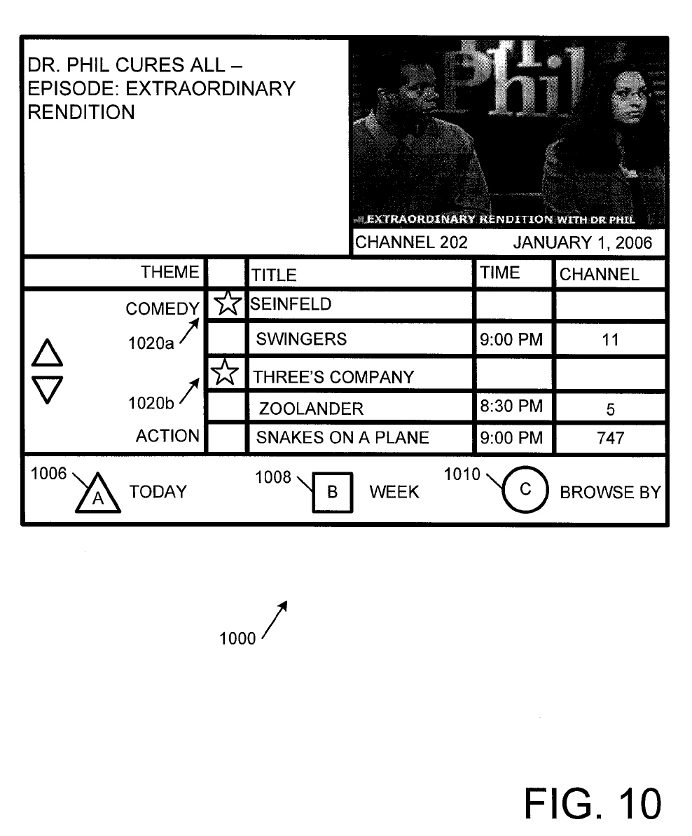

FIG. 10 is an embodiment of a programming display, illustrating a browsing format with a plurality of program titles, organized according to theme, similar to the display from FIG. 4.

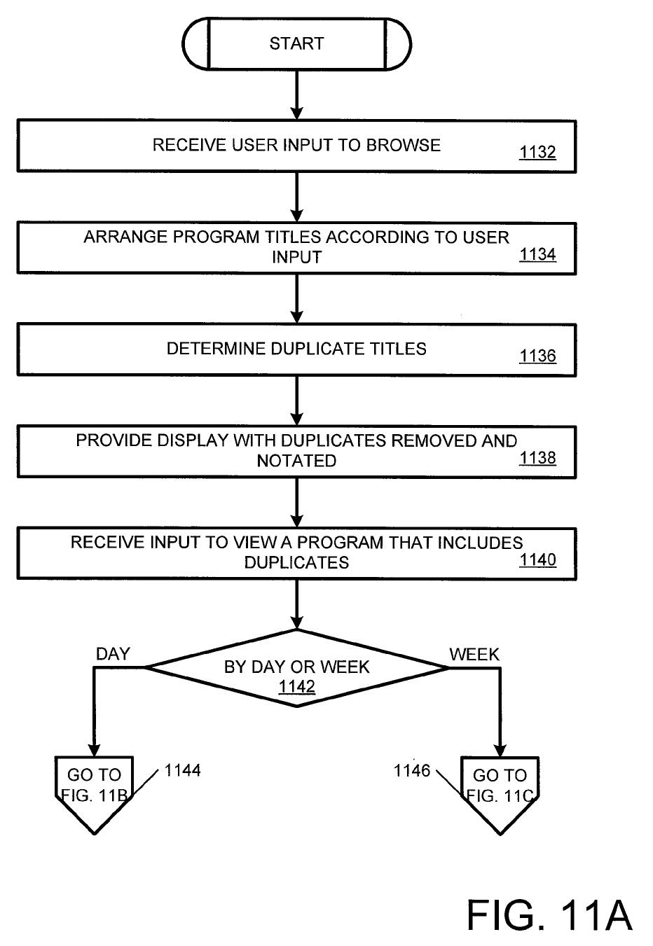

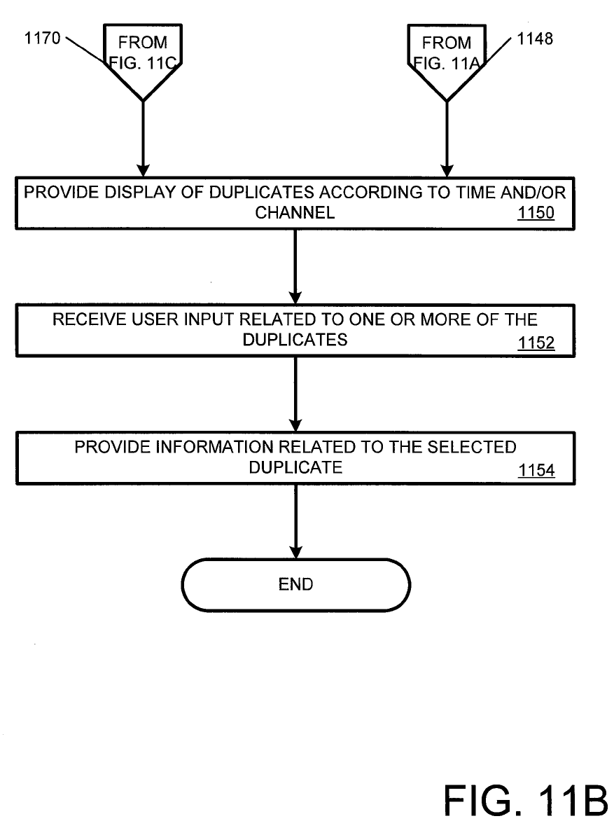

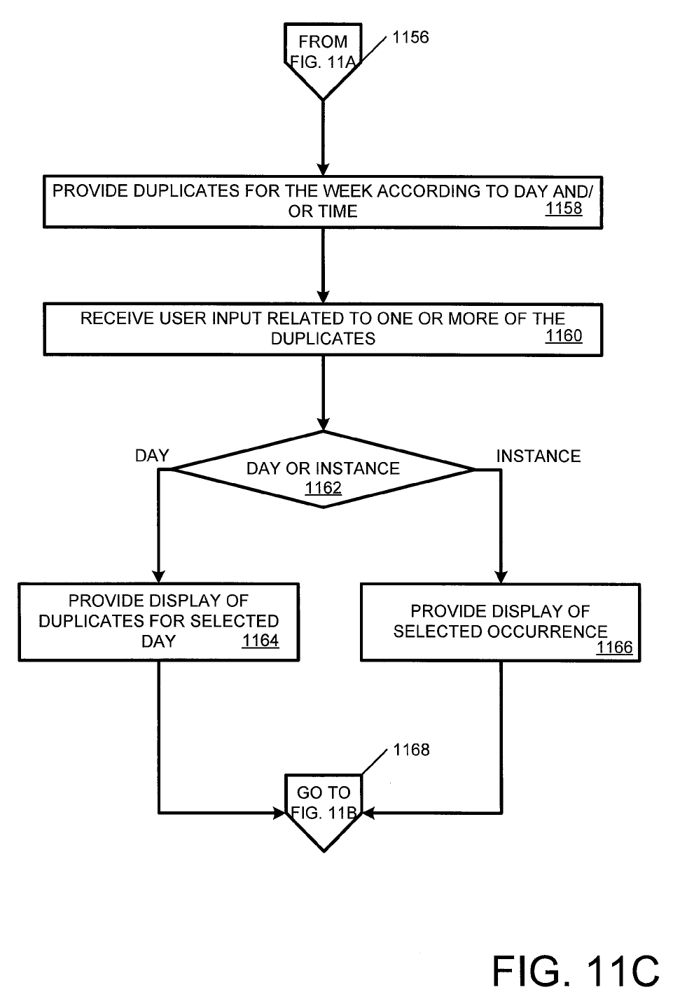

FIG. 11A is a flowchart illustrating actions that may be taken to provide program titles to a user of an STT, such as the STT from FIG. 2.

FIG. 11B is a continuation of the flowchart from FIG. 11A.

FIG. 11C is a continuation of the flowchart from FIG. 11B.

### DETAILED DESCRIPTION

FIG. 1 is a network diagram illustrating a plurality of STTs in operation. More specifically, the components illustrated in FIG. 1 can generally be implemented as part of a media network 100. FIG. 1 shows a view of a media network 100, which can take the form of a network system that can deliver video, audio, voice, and data services to set top users. Such a network can include a cable network, satellite network, Internet Protocol (IP) network, fiber-to-home network, and/or other network.

The media network 100 can be configured to provide programming signals as digitally formatted signals in addition to delivering analog programming signals. Further, media network 100 can also be configured to support one-way broadcast services as well as both one-way data services and two-way media and data services. The two-way operation of the media network 100 can allow for user interactivity with services, such as Pay-Per-View programming, Near Video-On-Demand (NVOD) programming according to any of several NVOD implementation methods, View-On-Demand (VOD) programming (according to any of several VOD implementation methods), and interactive applications, such as Internet connections and Interactive Media Guide (IMG) applications, among others.

The media network 100 may also be configured to provide interfaces, network control, transport control, session control, and servers to access content and services, and may be configured to distribute content and services to STT users from headend 102 via satellite 104a, PSTN 104b, and/or Internet 104c. As shown in FIG. 1, at least one embodiment of media network 100 includes a headend 102 and a plurality of hubs 110a-110e coupled to a transmission medium 111. The transmission medium 111 can include any configuration of networking logic for providing communication capabilities between components in the media network 100. Additionally included in the nonlimiting example of FIG. 1 is anode 112 coupled to hub 10a. Coupled to the node 112 are trunks 113a and 113b. Trunks 113 can facilitate the communication of programming data to the plurality of digital set top terminals (STTs) 114a-114d and a plurality of analog STTs 115a-115d. Display of the received data can be provided by display devices 116a-116h.

One can appreciate that, although a single headend 102 is illustrated in FIG. 1, a media network 100 can include any number of headends 102. Similarly, other components may be added to the media network 100 and/or removed from media network 100, depending on the desired functionality.

FIG. 2 is a block diagram illustrating exemplary components of an STT, similar to an STT from FIG. 1. More specifically, STT 114 includes an output system 218, which may be coupled to a display device 116, such as a television, computer monitor, etc. The output system 218 may be configured to receive data from a digital encoder 212. STT 114 additionally includes an input system 216, which can be configured to communicate with media network 100 and the headend 102. As discussed in more detail below, the input system 216 and the output system 218 may include one or more components such as an input port and an output port, respectively. Also included is a receiver 214 for receiving user commands via a remote control 205.

The STT 114 may also include a first composite output system 220, a first composite input system 222, a second composite output system 252, and a second composite input system 254. These input and output systems can be configured to facilitate communication of data between the STT 114 and other devices.

The STT 114 may also include a data storage infrastructure, such as Random Access Memory (RAM) 228 (which may include Dynamic RAM (DRAM), Video RAM (VRAM), Static RAM (SRAM), and/or other components) and flash memory 226. RAM 228 may include one or more software programs including a Digital Video Recorder (DVR) client 246 for receiving and storing received programming data, a graphics engine 248, a test application 244 and a browser 242. Similarly, flash memory 226 can include test application store 230, a watchTV component 240, and an operating system 232, which may include a resource manager component 238. Also included is a hard drive 224.

As one of ordinary skill in the art will realize, while certain components of FIG. 2 are illustrated as being stored in flash memory and other components are illustrated as being stored in RAM, this is a nonlimiting example. Depending on the particular configuration, any of these components may reside in either (or both) flash memory 226, RAM 228, and the hard drive 224. Additionally, other storage devices (volatile and/or nonvolatile storage) may also be included in the STT 114 for storing and providing access to these and other components.

The STT 114 may also include a transport processor 202 for executing instructions from the flash memory 226, RAM 228, and/or hard drive 224. A decoder 204 may be included for decoding received data, and a Moving Picture Experts Group (MPEG) demodulator 206 for demodulating the received data. A secure processor 208, a tuner system 210, and a digital encoder 212 may also be included.

One should note that while various components are illustrated in STT 114, this is a nonlimiting example. As one of ordinary skill in the art will realize, more or fewer components may be included to provide functionality for a particular configuration. Additionally, while the components of STT 114 are arranged in a particular manner, this is also a nonlimiting example, as other configurations are also considered.

FIG. 3 is an embodiment of a program guide display for presenting a plurality of program titles to a user, such as a user of the STT from FIG. 2. As illustrated in this nonlimiting example, media guide 300 includes a video display window 302, a program details window 304, a plurality of program titles, and a plurality of user options 306, 308, and 310. More specifically, upon selecting a “guide” option on STT 114 (e.g., by direct input, via remote control 205, etc.), media guide 300 can be displayed. Media guide 300 can be configured to display program titles related to a plurality of programs. As illustrated in FIG. 3, the program titles are organized according to the channel displaying these programs, as well as by a time the program is being displayed. As media guide 300 may include a plurality of other programming titles not being currently displayed, the media guide 300 can be configured to allow the user to scroll to different channels and/or times for locating a desired program title by providing user input to navigate the displayed media guide 300.

In addition to the organization of programming titles displayed in FIG. 3, the media guide 300 can also be configured to provide the user with options to change the organization of the program titles. More specifically, a “browse by” option 306 may be configured to arrange the program titles according to other criteria, such as by title, theme, and/or other criteria such that the user can view programming titles in a browsing format. Additionally, a “date” option 308 can also be provided for providing display of programming titles for one or more days in the current week. “Return” option 310 can be configured to return the user to the currently viewed program.

FIG. 4 is an embodiment of a programming display for selecting a display configuration of the program titles from FIG. 3. More specifically, by selecting “browse by” option 302, the user can be provided with a “browse by” window 400 for selecting whether to browse the program titles according to title, channel, and/or theme. As the display of FIG. 3 displays the program titles according to channel, the user may desire to view the program titles according to another configuration. One should note that, while a “browse by” window 400 can be displayed, this information and options can also be provided within the media guide 300. Other configurations are also considered.

FIG. 5 is an embodiment of a programming display for presenting a plurality of programming titles in a browsing format according to title, similar to the display from FIG. 4. More specifically, FIG. 5 illustrates an embodiment of displaying program titles according to title. As illustrated in this nonlimiting example, the program titles available to the media guide are alphabetized, with duplicates being arranged according to display time. While such a configuration may provide the user with a program title arrangement for locating a desired program quickly, such an arrangement may have many duplicate titles. As illustrated in FIG. 5, the program “Seinfeld” is displayed four times. As the user may not desire to view this program, the user must scroll through a plurality of unwanted duplicate program titles to arrive at a desired program title.

FIG. 6 is an embodiment of a programming display for presenting a plurality of programming titles in a browsing format with access to duplicate programming titles, similar to the display from FIG. 5. As illustrated, a plurality of program titles for a particular day are displayed alphabetically. Additionally, as illustrated in this nonlimiting example, the duplicate program titles have been hidden such that each program title is displayed once (or a reduced number of times). Additionally included in FIG. 6 are duplicate program indicators, 620a, 620b, which may be used to identify the program titles that have duplicates not being displayed. In such a configuration, the user can quickly scroll through the unwanted program titles to arrive at a desired program title. If the desired program is identified with duplicate program indicator 620, the user can select the duplicate indicator 620 to display the additional program titles. Also included in the nonlimiting example of FIG. 7 are options 606 and 608 for viewing program titles according to day and week, respectively, as well as “browse by” option 610 to return to a previous menu and/or viewed program.

FIG. 7 is an embodiment of a programming display, illustrating a browsing format with a plurality of duplicate titles for a particular day, similar to the display from FIG. 7. As illustrated in media guide 700, upon selection of duplicate program indicator 620a, the user can be provided with a plurality of programs with the same (or similar) titles. More specifically, as “Seinfeld” was selected, the programs being displayed in the determined time period (in this nonlimiting example today) with the title “Seinfeld” are displayed. As illustrated the program titles may be displayed according to channel and/or time. Additionally, data indicator 718 can be included to illustrate that other titles, not currently being displayed, are also available. The user may also view other time periods, by selecting “browse by” option 706, “date” option 708, and “return” option 710, which can return the user to media guide 600 (FIG. 6). A date of displayed program titles may also be displayed in media guide 700 (e.g., Jan. 2, 2006).

As indicated above, “browse by” option 706 can return the user back to FIG. 4 and/or return the user to the currently viewed program. “Date” option 708 can provide the user with the ability to determine the date (or date range) for viewing program titles.

One should note that while the nonlimiting example of FIG. 7 illustrates an arrangement of duplicate titles in a two-dimensional matrix format, this is a nonlimiting example. More specifically, in at least one configuration, program duplicates may be arranged in a column. In such a configuration, because the title is known, the display time can be included within the space normally reserved for the title. Similarly, other configurations can provide an arrangement that includes displaying the duplicate titles in a row, with channel being displayed with the program title. Other configurations are also considered.

FIG. 8 is an embodiment of a programming display, illustrating a browsing format with a plurality of duplicate titles for a particular week, similar to the display from FIG. 7. More specifically, the nonlimiting example of FIG. 8 can be accessed by selection of “date” option 708, among others. Regardless, if the user desires to view the duplicate titles according to a particular week, media guide 800 can be displayed. As illustrated, media guide 800 can include a display of one or more days of the week, as well as times the duplicate program is being presented. By selecting the desired day with cursor 822, the user can be presented with media guide 800 for the selected day. Also included are “browse by” option 806 (which can return the user to FIG. 4), and “date” option 808. “Return” option 810 can return the user to display 600 (FIG. 6).

FIG. 9 is an embodiment of a programming display, illustrating selection of a program title, such as a program title from FIG. 8. As illustrated in FIG. 8, media guide 800 can be configured to display duplicate program titles for a particular week. As illustrated, the user can position cursor 822 over a particular instance of a program title (in this nonlimiting example, Tuesday at 8:00 PM). By selecting a particular instance of a programming title, the user can be presented with a menu guide (not shown) directed to the selected instance. Other configurations can, in response to selecting of a particular instance, provide the user with menu guide 800, with the particular instance highlighted and/or otherwise visible to the user.

FIG. 10 is an embodiment of a programming display, illustrating a browsing format with a plurality of program titles, organized according to theme, similar to the display from FIG. 4. More specifically, the user can access menu guide 1000 by selecting “theme” option in “browse by” window 400. As illustrated in media guide 1000, the program titles can be arranged according to theme. As comedy is the first theme displayed, a plurality of program titles are displayed alphabetically within that theme. Also included is an action theme, as well as others not currently displayed. Similar to the media guide 600, media guide 1000 includes duplicate program indicators 1020a, 1020b for providing access to media guides 700 and 800. Also included are “today” option 1006, “week” option 1008, and “return” option 1010.

FIG. 11A is a flowchart illustrating actions that may be taken to provide program titles to a user of an STT, such as the STT from FIG. 2. As illustrated in the nonlimiting example of FIG. 11A, the STT can receive user input to browse a plurality of program titles (block 1132). The user input can include an indication to browse program titles according to channel, title, theme, and/or other criteria, such as for example a selection of an option in browse by menu 400 from FIG. 4. The STT can then arrange the program titles according to the user input (block 1134). The STT can determine whether there are duplicate (and/or similar) program titles (block 1136) and, if so, provide a browse display with the duplicates removed and notated (block 1138). The duplicate program titles can be notated with a duplicate program indicator 620, 1020, however this is not a requirement. The STT can then receive input to view a program title that includes duplicates (block 1140). The STT can then determine whether to display the duplicates according to day, week, or other time-dependent format (block 1142). More specifically, referring back to FIG. 7, the STT can make this determination based on a user selection of an option in “time period” window 700 from FIG. 7. Additionally, at least one embodiment may be configured to default to day, week, or other time-dependent format. If STT determines that the user desires to view the duplicates according to day, the flowchart proceeds to jump block 1144 (continued in FIG. 11B). If the STT determines that the user desires to view the duplicates according to week, the flowchart proceeds to jump block 1146 (continued in FIG. 11C).

FIG. 11B is a continuation of the flowchart from FIG. 11A. If the STT determines that the user desires to view duplicate program titles according to day, the flowchart proceeds from jump block 1148, to provide a display of duplicates according to time/and or channel (block 1150). The STT can then receive user input related to one or more of the duplicates (block 1152) by, for example, selecting duplicate program indicator 620. The STT can then provide information related to the selected duplicate program title (block 1154), such as channel and broadcast time.

FIG. 11C is a continuation of the flowchart from FIG. 11B. If the STT determines that the user desires to view the duplicate program titles according to week, the flowchart proceeds from jump block 1156 to provide duplicates for the week according to day and/or time (block 1158). The STT can then receive user input related to one or more of the duplicates (block 1160), such as for example, a user selection indicating whether to provide a display for a specific program or whether to provide display for a particular day of programming, see FIGS. 8, 9). The STT can determine whether the received user input relates to a day or to a particular programming instance (block 1162). More specifically, in at least one embodiment, the STT can determine whether the user selected a day (FIG. 8) or whether the user selected a particular instance (FIG. 9). If the received user input relates to a day, the STT can provide a display of the duplicate program titles for the selected day (block 1162). The flowchart can then proceed to jump block 1168, continued in FIG. 11B. If, on the other hand, the STT determines that the received user input relates to a particular programming instance, the STT can provide display of the selected programming instance (block 1166). The flowchart can then proceed to jump block 1168, continued in FIG. 11B

Returning to FIG. 11B, at jump block 1170, regardless of whether the user input relates to a particular day or a particular programming instance, the STT can provide a display of the titles one or more duplicates according to time and/or channel (block 1150). The STT can then receive user input related to one of more of the duplicates (block 1152) by, for example, selecting duplicate program indicator 620. The STT can then provide information related to the selected duplicate (block 1154).

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order or not at all, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

1. A method for providing an enhanced program guide, comprising:
receiving a request to provide a plurality of program titles in a browsing format;
determining whether at least one of the program titles is a duplicate program title;
in response to determining that at least one of the program titles is a duplicate program title, providing a display that includes the requested program titles, the display excluding the at least one duplicate program title, and the display providing an option to view the at least one duplicate program title; and
in response to receiving a request to view the at least one duplicate program title, providing the at least one duplicate program title according a time-dependent format.

2. The method of claim 1, wherein the time-dependent format includes a daily format.

3. The method of claim 2, wherein providing the at least one duplicate program title according to a daily format includes providing an interactive menu that includes a broadcast time for the at least one duplicate program title in a particular day.

4. The method of claim 1, wherein the time-dependent format includes a weekly format.

5. The method of claim 4, wherein providing the at least one duplicate program title according to a weekly format includes providing an interactive menu that includes a broadcast time for the at least one duplicate program title in a particular week.

6. The method of claim 1, further comprising providing a user option to provide the at least one duplicate program title according to the daily format.

7. The method of claim 1, further comprising providing a user option to provide the at least one duplicate program according to the weekly format.

8. A computer readable medium for providing an enhanced program guide, comprising:
receiving logic configured to receive a request to provide a plurality of program titles in a browsing format;
determining logic configured to determine whether at least one of the program titles is a duplicate program title;
option logic configured to, in response to determining that at least one of the program titles is a duplicate program title, provide a display that includes the requested program titles, the display excluding the at least one duplicate program title, and the display providing an option to view the at least one duplicate program title; and
format logic configured to, in response to receiving a request to view the at least one duplicate program title, provide the at least one duplicate program title according a time-dependent format.

9. The computer readable medium of claim 8, wherein the time-dependent format includes a daily format.

10. The computer readable medium of claim 9, wherein the format logic is further configured to provide an interactive menu that includes a broadcast time for the at least one duplicate program title in a particular day.

11. The computer readable medium of claim 8, wherein the time-dependent format includes a weekly format.

12. The computer readable medium of claim 11, wherein the format logic is further configured to provide an interactive menu that includes a broadcast time for the at least one duplicate program title in a particular week.

13. The computer readable medium of claim 8, wherein the format logic is further configured to provide a user option to provide the at least one duplicate program title according to the daily format.

14. The computer readable medium of claim 8, wherein the format logic is further configured to provide a user option to provide the at least one duplicate program title according to the weekly format.

15. A system for providing an enhanced program guide, comprising:
a receiving component configured to receive a request to provide a plurality of program titles in a browsing format;
a determining component configured to determine whether at least one of the program titles is a duplicate program title;
an option component configured to, in response to determining that at least one of the program titles is a duplicate program title, provide a display that includes the requested program titles, display excluding the at least one duplicate program title, and the display providing an option to view the at least one duplicate program title; and
a format component configured to, in response to receiving a request to view the at least one duplicate program title, provide the at least one duplicate program title according to a time-dependent format.

16. The system of claim 15, wherein the time-dependent format includes a daily format.

17. The system of claim 16, wherein the format component is further configured to provide an interactive menu that includes a broadcast time for the at least one duplicate program title in a particular day.

18. The system of claim 15, wherein the time-dependent format includes a weekly format.

19. The system of claim 18, wherein the format component is further configured to provide an interactive menu that includes a broadcast time for the at least one duplicate program title in a particular week.

20. The system of claim 15, wherein the format logic is further configured to provide a user option to provide the at least one duplicate program title according to the time-dependent format.
